(19) United States
(12) Patent Application Publication
(10) Pub. No.: US 2018/0185117 A1
(43) Pub. Date: Jul. 5, 2018

(54) Injection Device

(71) Applicant: Ivoclar Vivadent AG, Schaan (LI)

(72) Inventors: Reinhard GOERGE, Heerbrugg (CH); Nora Christina KÖGEL, Oberriet (CH)

(21) Appl. No.: 15/738,940

(22) PCT Filed: Jun. 23, 2016
(86) PCT No.: PCT/EP2016/064513

§ 371 Date: Dec. 21, 2017

(30) Foreign Application Priority Data
Jul. 2, 2015 (EP) 15175019.7

(51) Int. Cl. A61C 5/62; A61C 5/66

(52) U.S. Cl. CPC A61C 5/62; B05C 17/00593; A61C 5/66

(57) ABSTRACT

The invention relates to an injection device with an injector (12) and with a cartridge (14) that contains dental material and can be inserted into or attached onto the injector (12), said injector (12) having a piston (28) which, as it enters the cartridge (14), is intended to press the dental material out of the cartridge (14), said cartridge (14) having a collar (16) which is intended to bear on a holding projection (20) of the injector (12). The holding projection (20) is formed on a guide element (36) of the injector (12). The guide element (36) has a sensor (50) for a code (52) which is applied to the cartridge (14), and the injector (12) has a display at an area spaced apart from the holding projection (20), particularly on the top face, or obliquely on the top face, in the rear area of the injector (12). On the basis of the output signal of the sensor (50) and the code (52) of the cartridge (14), the top face reproduces at least one parameter of the cartridge (13) and/or of the dental material located in the latter.

The invention relates to an injection device, according to the preamble of claim 1.

Such an injection device has already been known for some time, for example from DE 1 99 45 706 B1. Such an Injection device comprises an Injector that can be designed in cartridge form as in the above mentioned patent or also in pencil form as for example in DE 1 96 18 544 C1. The object of the injector is to press out the dental material in the cartridge to allow the dentist to apply the dental material to the location requiring treatment. For this purpose, a stamp or piston is provided which can enter the cartridge where it has an external diameter corresponding to the internal diameter of the cartridge, such that the dental material can be pressed out.

The injector is large in comparison with the cartridge. Usually, to transfer the force to the piston, a two-arm lever is used with a force transfer ratio such as 5:1, such that the force applied to the piston is five times the manual force. The cartridge must absorb this force. For this purpose, a stable collar is required and provided at the rear end of the cartridge. This collar bears on a holding projection of the injector, which is to transfer the force of the collar to the injector.

To provide a sufficient surface for transferring the force, the holding projection—according to DE 1 99 45 706 B1—extends across the entire circumference of the cartridge where it covers the cartridge completely. In a modified embodiment, it extends for example across 240° of the cartridge, such that it can be pressed into the injector from below to bear on a guide element. Even then, a substantial part of the cartridge is covered by the injector.

A large number of different cartridges are available with various dental materials. This relates not only to the colour, but especially also to the material. Light-curing dental materials vary considerably as to their recommended curing time and light intensity. The cartridges therefore have different inscriptions, but the space available for the recommended curing time and light intensity is usually insufficient, since the cartridge typically has a diameter of only 6 mm.

In the state in which the cartridge is inserted in the injector, it is practically impossible to check which cartridge has just been inserted into the injector, since it is at least partly, covered by the guide element and the holding projection of the injector.

Typically, the cartridges are black to prevent extraneous light leading to premature curing, and therefore the cartridges cannot be differentiated by colour. Instead, the cartridge has to be removed from the injector and inspected closely before it can be used further.

On a busy day in a dental practice it cannot be ruled out that mistakes occur, which cannot only lead to damage claims against the dentist but also to the danger that due to incomplete curing, a monomer part can remain in the dental material. There are indications in the literature that the residual free radicals can be at least of limited carcinogenicity.

For those reasons, it is the object of the present invention to provide an injection device according to the generic part of claim 1, which allows an ergonomically favourable as well as, in particular, also safe handling not requiring any special expenditure of time.

According to the invention, this object is achieved by claim 1. Advantageous embodiments are described in the sub-claims.

To begin, according to the invention, it is especially favourable that cartridges of a large diameter can be used which according to the invention are provided with a coding, and which can be produced at the same manufacturing costs as the previously available cartridges. In addition to the manufacturer's code imprinted in short form, and the used material and its colour, a machine-readable code is simply applied to the cartridge. For example, the code can be a bar code, an OP code or any other machine-readable code. It is also possible to use embossing or appropriately durable imprinting to apply a code that resembles braille.

According to the invention, the injector is provided in the area of the guide elements, preferably adjacent to the holding projection, with a sensor that is directed toward the cartridge where the code is applied. This refers to the axial length or the axial direction of the cartridge. Preferably, the code is printed all around or at least almost all around the circumference of the cartridge because it should be possible for the dentist to select the turning position of the cartridge in the guide element at his/her discretion, especially when the outlet grommet of the cartridge is offsetting.

The all-around code ensures that at least part of the code is available to be read by the sensor also when the turning position of the cartridge is changed.

According to the invention, the sensor's output signal is directed to a display, in a preferred embodiment via a control device. The display shows in readable form how light is to be applied to the dental material, i.e. what curing time and what light intensity is recommended. Furthermore, other suitable information is shown on the display, such as the colour of the dental materials, the name of the dental material, the viscosity—flow or not—, and also the date of expiry.

For this purpose, the display is placed on the back of the injector above the injector grip, preferably with a slight incline to improve readability. The width of the display can be adapted to the slim width of the injector. For example, if the injector has a width of 23 mm, a display that is 20 mm wide can be accommodated with an appropriately compact design of the display. If, for example, the height of the display is 40 mm, there is still enough information available, since the display would have a surface of 8 cm².

If a colour display is used, it is possible, for example, to mark the background of the display in the colour of the dental material to signal the colour in a compact form.

Any suitable material can be used as dental material: preferably a composite, but also light-curable polymers, filler materials, dental cement, other adhesives or any other viscous dental materials that can be applied in cartridge form.

According to the invention, it is particularly favourable if the display or the wording can be without any abbreviations that are not self-explanatory, since, for example, the wording can include ten times as much text as the printable cartridge surface.

According to the invention, mistakes can thus be avoided, and working in the dental practice is considerably safer with the invention.

An advantageous embodiment of the invention provides that the sensor is arranged longitudinally along the length of the cartridge and combined, for example, with a capacitive fill level indicator. With this solution, the display can show the pressed-out volume of the dental material, but also the remaining volume still available.

Another preferred embodiment provides that the display, the control device and the sensor are designed as a retractable insert within the injector. This insert can be pulled out for autoclaving the injector.

It is also particularly favourable when the dentist—if working with more than one identical injectors, each provided with cartridges—can look at the display and see the difference right away, thus avoiding mistakes.

Other advantages, details and characteristics can be seen from the following description of two embodiments of the invention, wherein

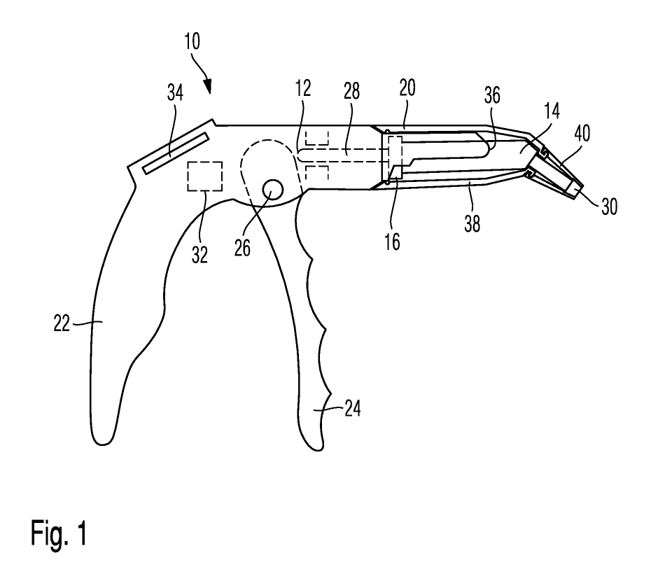

FIG. 1 shows a schematic view of an embodiment of the injection device according to the invention, and

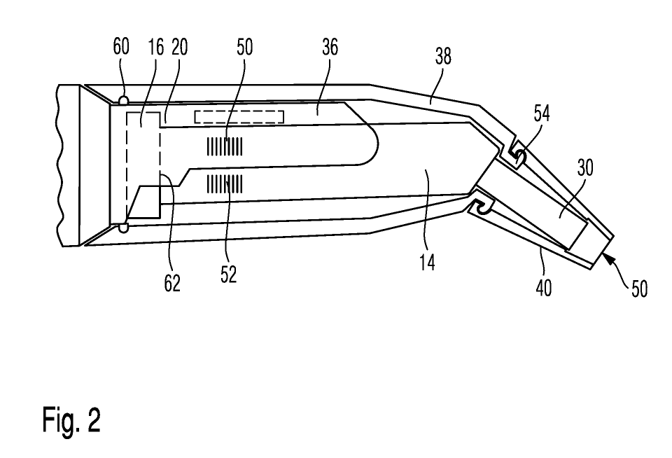

FIG. 2 shows an enlarged view of a detail of the injection device according to a modified embodiment of the invention.

The injection device 10 shown in FIG. 1 comprises an Injector 12 and a cartridge 14. Cartridge 14 is inserted into injector 12. In its rear area, it has a circularly extending collar 16. Looking in the direction of the application of the material, it bears on an internal holding projection 20 of injector 12, which forms a stop against collar 16.

Injector 12 has a grip 22 in a manner known per se, and an actuating lever 24. Actuating lever 24 is mounted to injector 12 via an axis 26. It is of finger-friendly design; by pulling the actuating lever 24 in the direction of grip 22, the latter moves a piston 28 inside injector 12 towards cartridge 14.

Piston 28 fits into the cartridge and serves the purpose of pressing out the dental material therein.

Cartridge 14 also comprises an outlet grommet 30 which extends obliquely toward axis 26 of cartridge 14 and which has a smaller diameter than cartridge 14.

According to the invention, cartridge 14 is provided with a code 52 shown in FIG. 2. This code is read by a sensor 50 also shown in FIG. 2. The output signal of sensor 50 is transmitted to a control device 32 where it is processed. A display 34 provides detailed information about cartridge 14 in readable form.

For this purpose, display 34 is placed above grip 22 in the rear area of injector 12, in a slightly slanted position such that it can be seen easily by the operator.

In the embodiment according to FIG. 1, a rotating sleeve 38 is provided on holding projection 20 and guide element 36 on which cartridge 14 is bearing and which is extending forward in the barrel extension of injector 12, overlapping cartridge 14.

Rotating sleeve 38 ends in an outlet opening through which outlet grommet 30 passes. The normal of the outlet opening is parallel to the axis of outlet grommet 30.

In addition, the outlet opening of rotating sleeve 38 is covered by a replacement cap 40. This cap has an outlet opening through which the dental material exiting outlet grommet passes to be directed to the treatment site.

It is particularly advantageous according to the invention that cartridge 14 is completely covered by rotating sleeve 38 and replacement cap 40. This ensures that there can be no contact between the patient and cartridge 14.

While until now, cartridges could not be autoclaved because they contain sensitive dental material, which meant that regulations specified that cartridges had to be single-use only, the invention is now making it possible that cartridge 14 can be used for several patients.

For this purpose, rotating sleeve 28 together with the replacement cap 40 can be removed from the injector 12, namely while cartridge 14 is inserted in the injector. Rotating sleeve 38 is made of a somewhat elastic material which, however, is temperature-resistant such that it can be autoclaved together with replacement cap 40.

For the renewed use of the device according to the invention, the rotating sleeve is pulled over cartridge 14 and pushed onto the shaft of injector 12 until it locks into place. Then the replacement cap is pushed onto the bearing on the rotating sleeve 38 where it is locked. In normal use—at an appropriately safe distance—the replacement cap 40 and rotating sleeve 38 cannot be loosened by mistake.

If only the replacement cap 40 comes in contact with the patient's mouth, it is also possible to pull only it off and autoclave it.

Another embodiment of the invention is shown in FIG. 2. It shows how a sensor 50 extends on the inside of guide element 36 along cartridge 14. Sensor 50 reads code 52, which is at least partly attached to the circumference of cartridge 14. The cartridge is rotatable about its axis related to holding projection 20 and guide element 36. The code and sensor 50 are selected such that independently of the rotational position of cartridge 14, a part of the code can always be read by sensor 50.

In the embodiment according to FIG. 2, the forward part of rotating sleeve 38 comes still closer to cartridge 14. For this purpose, it is of conical shape there. As shown, it ends in an outlet spigot 52, which has a ring projection on which replacement cap 40 can be snap-locked. Replacement cap 40 completely surrounds outlet grommet 30 and extends beyond it. It is also of conical shape such that the end diameter at the front end of replacement cap 40 substantially matches the end diameter of outlet grommet 30. The outlet opening 56 of replacement cap 40 therefore has an inside diameter that substantially matches the inside diameter of outlet grommet 30.

Guide element 36 extends across a substantial part of cartridge 14. In the embodiment shown in frontal view, it extends in semi-circular form across somewhat more than 180°, for example 200° or 240°. Guide element 36 is open on the bottom. Thus, due to a certain elasticity of guide element 36, cartridge 14 can snap into the operating position as shown in FIG. 2 where it is held captive.

In this respect, guide element 36 forms a clamping arrangement 62 for cartridge 14, with the two clamping fingers gripping cartridge 14 and holding it.

Due to this clamping arrangement, the exact positioning between code 52 and sensor 50 is also possible.

In another advantageous embodiment, it is provided that the actuating lever 24—in addition to piston 28—also drives a small generator, which feeds power to a battery for the display and the control device.

In another advantageous embodiment, a micro switch is provided on the actuating lever 24 which controls that the energy supply is only switched on when the actuating lever is pulled slightly, for example by 5 mm. This design saves energy, and as soon as the dentist takes the injection device in his/her hand and slightly presses the actuating lever, control device 32 according to the invention is activated with display 34 and sensor 50, and the information and parameters relevant to the dental material are displayed.

Sensor 50 reads all information contained in code 52. Typically, at least one parameter of the cartridge and accordingly also the dental material it contains are shown on display 34. It is also possible to pre-set the information and parameters that are to be displayed as the dentist wishes.

FIG. 2 also shows that at the end of rotating sleeve 38, on the shaft of injector 12, a ring projection 60 is formed. This snap-locks in an associated groove in rotating sleeve 38 without interfering with the rotatability of rotating sleeve 38.

1. An injection device comprising
an injector (12) and
a cartridge (14) that contains dental material and can be inserted into or attached onto the injector (12),
said injector (12) comprising a piston (28) which, as it enters the cartridge (14) is intended to press the dental material out of the cartridge (14),
said cartridge (14) having a collar (16) which is intended to bear on a holding projection (20) of the injector (12), whereby the holding projection (20) is formed on a guide element (36) of the injector (12),
wherein the guide element (36) has a sensor (50) for a code (52) which is applied to the cartridge (14), and
wherein the injector (12) has a display at an area spaced apart from the holding projection (20), and
wherein the output signal of the sensor (50) and the code (52) of the cartridge (14) reproduces at least one parameter of the cartridge (14) and/or of the dental material located in the cartridge (14).

2. The injection device according to claim 1,
wherein the code (52) is machine-readable, applied to the cartridge (14) and extends at least in part circularly around the cartridge (14), and
wherein independently of the rotational position of the cartridge (14), a complete code (52) in or on the guide element (36) is always readable by the sensor (50).

3. The injection device according to claim 1,
wherein the guide element (36) has a clamping arrangement, comprising two clamping fingers opposite each other and partly overlapping the cartridge (14), and
wherein the clamping arrangement is clamping and holding the cartridge as it bears on the guide element (36).

4. The injection device according to claim 1,
wherein the cartridge (14) has an obliquely extending or offsetting grommet sleeve (30) through which the dental material can be pushed out.

5. The injection device according to claim 1,
wherein the Injection device (10) is substantially in pistol shape with a grip (22), opposite which is an actuating lever (24) which lever (24) acts upon the piston (28) in the form of a two-arm lever by transmitting the force and reducing the path.

6. The injection device according to claim 1,
wherein the injector (12) has a control device (32) which processes the output signal of the sensor (50) and activates the display, which display shows readable signs and/or symbols.

7. The injection device according to claim 1,
wherein the injector (12) has an actuating lever (24) which acts upon the piston (28) via a gear unit and
wherein the actuating lever (24) drives a generator for feeding into a rechargeable battery in the injector (12).

8. The injection device according to claim 1,
wherein the injector (12) has an actuating lever (24) acting upon a switching contact, which supplies the display and the sensor (50) with power from a battery.

9. The injection device according to claim 1,
wherein the guide element (36) and the cartridge (14) are accommodated in a rotational sleeve (38) which is rotatably mounted on the injector and which extends substantially parallel to the cartridge (14).

10. The injection device according to claim 1,
wherein the rotational sleeve (38) has an outlet spigot, which extends obliquely to the axis (26) of the cartridge (14) and substantially in the direction of an outlet grommet of the cartridge (14).

11. The injection device according to claim 9,
wherein the rotational sleeve (38) has a connection for a replacement cap (40) that is bearing on an outlet spigot of the rotational sleeve (38) and extends around and beyond the outlet grommet of the cartridge (14).

12. The injection device according to claim 11,
wherein the replacement cap (40) fits onto an outlet grommet of the rotational sleeve (38) and has an outlet opening which has substantially the same diameter as an outlet opening of the outlet grommet, with a maximum deviation of plus or minus 30%, whereby the replacement cap (40) is in particular conically tapered.

13. The injection device according to claim 11,
wherein the rotational sleeve (38) and/or the replacement cap (40) are mounted rotationally on the Injector (12) or on the outlet spigot and can be removed after overcoming a latching force.

14. The injection device according to claim 13,
wherein the rotational sleeve (38) and/or the replacement cap (401 are made of a material that can be autoclaved, with a temperature resistance for 150° C. or more, and
wherein the material of the rotational sleeve (38) and/or the replacement cap (40) is softer and more elastic than the material of the cartridge (14) and/or of the rest of the injector (12).

15. The injection device according to claim 14,
wherein the rotational sleeve (38) has a cylindrical section in the area of the guide element (36) and
wherein rotational sleeve (38) is substantially conically tapered toward the outlet spigot.

16. The injection device according to claim 1,
wherein the display is diposed on a top face or obliquely on the top face in a rear side of the injector (12).
